(19) United States
(12) Patent Application Publication
(10) Pub. No.: US 2024/0044663 A1
(43) Pub. Date: Feb. 8, 2024

(54) SYSTEM AND METHOD FOR PREDICTING DESTINATION LOCATION

(71) Applicant: GRABTAXI HOLDINGS PTE. LTD., Singapore (SG)

(72) Inventors: Xiang Hui Nicholas LIM, Singapore (SG); Bryan Kuen Yew HOOI, Singapore (SG); See Kiong NG, Singapore (SG); Xueou WANG, Singapore (SG); Yong Liang GOH, Singapore (SG); Renrong WENG, Singapore (SG); Rui TAN, Singapore (SG)

(21) Appl. No.: 18/256,649

(22) PCT Filed: Feb. 9, 2022
(86) PCT No.: PCT/SG2022/050065

§ 371 Date: Jun. 9, 2023

(30) Foreign Application Priority Data
Mar. 2, 2021 (SG) 10202102123Q

(51) Int. Cl. G01C 21/36; G01C 21/34

(52) U.S. Cl. CPC G01C 21/3617; G01C 21/3484; G01C 21/3446

(57) ABSTRACT

A system for predicting a destination location may include one or more processors and a memory having instructions stored therein. The one or more processors may use at least one recurrent neural network to: process spatial data which may include a first set of information about origin locations and destination locations; process temporal data which may include a second set of information about times at the origin locations and the destination locations; determine hidden state data based on the spatial data and the temporal data, wherein the hidden state data may include data on origin-destination relationships; receive a current input data from a user, wherein the current input data may include an identity of the user and the current origin location of the user; and predict the destination location based on the hidden state data and the current input data.

### TECHNICAL FIELD

Various aspects of this disclosure relate to a system for predicting a destination location. Various aspects of this disclosure relate to a method for predicting a destination location. Various aspects of this disclosure relate to a non-transitory computer-readable medium storing computer executable code comprising instructions for predicting a destination location. Various aspects of this disclosure relate to a computer executable code comprising instructions for predicting a destination location.

### BACKGROUND

Predicting the destination of a trip is a task in human mobility which finds several applications in real-world scenarios, from optimizing the efficiency of electronic dispatching systems to predicting and reducing traffic jams. In particular, it is of interest in the context of ehailing, which, thanks to the advance of smartphone technology, has become popular globally and enables customers to hail taxis using their smartphones.

Next destination recommendations are important in the transportation domain of taxi and ride-hailing services, where users are recommended with personalized destinations given their current origin location.

For predicting a user's next destination, models such as frequency, sequential learning, matrix factorization may be used to predict the user's next destination based on a user's visiting sequence. Existing works for next destination recommendation task are not designed to learn from both origin and destination sequences. They are designed to only learn from destination sequences. Therefore, the existing solutions may not be accurate and may provide less contextualized and impractical recommendations (e.g. very far away destinations).

More importantly, existing works does not consider the current inputted origin location by the user to perform the recommendation, this makes it highly impractical in real world applications as very far destinations may be recommended even when the user tends to take a ride to nearby places, leading to sub-optimal performance.

### SUMMARY

Therefore, it is desirable to increase the accuracy of predicting a destination location and to achieve an accurate and reliable prediction of a vehicle's (or, equivalently, a user's) destination.

An advantage of the present disclosure may include an accurate and reliable prediction of a destination location by learning the sequential transitions from both origin and destination sequences.

An advantage of the present disclosure may include a reliable prediction system which may be origin-aware, meaning that it performs prediction based on knowledge of where the user is currently at or their inputted origin location.

An advantage of the present disclosure may include personalization of prediction of a destination location which may be achieved through user embedding to learn and compute a hidden representation that best represents the user's current preference to best predict the next destination. This may be interpreted as a system being able to understand user preferences.

These and other aforementioned advantages and features of the aspects herein disclosed will be apparent through reference to the following description and the accompanying drawings. Furthermore, it is to be understood that the features of the various aspects described herein are not mutually exclusive and can exist in various combinations and permutations.

The present disclosure generally relates to a system for predicting a destination location. The system may include one or more processors. The system may also include a memory having instructions stored there, in the instructions, when executed by the one or more processors, may cause the one or more processors to use at least one recurrent neural network to: process spatial data which may include a first set of information about origin locations and destination locations; process temporal data which may include a second set of information about times at the origin locations and the destination locations; determine hidden state data based on the spatial data and the temporal data, wherein the hidden state data may include data on origin-destination relationships; receive a current input data from a user, wherein the current input data may include an identity of the user and the current origin location of the user; and predict the destination location based on the hidden state data and the current input data.

According to an embodiment, the current input data further may include a previous destination of the user.

According to an embodiment, the first set of information may include local origin locations and local destination locations. The second set of information may include times at the local origin locations and the local destination locations. The local origin locations and the local destination locations may be within a geohash.

According to an embodiment, the first set of information may include global origin locations and/or global destination locations The second set of information may include times at the global origin locations and/or the global destination locations. The global origin locations and/or the global destination locations may be outside of the geohash.

According to an embodiment, the system may include an encoder. The encoder may be configured to process the spatial data and the temporal data. The encoder may be configured to determine the hidden state data.

According to an embodiment, the system may include a decoder. The decoder may be configured to receive the current input data from the user. The decoder may be configured to receive the hidden state data from the encoder. The decoder may be configured to predict the destination location based on the hidden state data and the current input data.

According to an embodiment, the decoder may be configured to determine personalized preference data of the user based on the hidden state data, the current input data and a first predetermined weight.

According to an embodiment, the decoder may be configured to predict the destination location based on the personalized preference data and the hidden state data with a second predetermined weight.

According to an embodiment, the decoder may be configured to determine a probability that the destination location predicted is a correct destination location.

The present disclosure generally relates to a method for predicting a destination location. The method may include: using at least one recurrent neural network to: process spatial data comprising information about origin locations and destination locations; process temporal data comprising information about times at the origin locations and the destination locations; determine origin-destination relationships based on the spatial data and the temporal data; receive a current input data from a user, wherein the current input data comprises an identity of the user and the current origin location of the user; and predict the destination location based on the origin-destination relationships and the current input data.

According to an embodiment, the current input data further may include a previous destination of the user.

According to an embodiment, the first set of information may include local origin locations and local destination locations. The second set of information may include times at the local origin locations and the local destination locations. The local origin locations and the local destination locations may be within a geohash.

According to an embodiment, the first set of information may include global origin locations and/or global destination locations The second set of information may include times at the global origin locations and/or the global destination locations. The global origin locations and/or the global destination locations may be outside of the geohash.

According to an embodiment, the method may include using an encoder to: process the spatial data and the temporal data; and determine the hidden state data.

According to an embodiment, the method may include using a decoder to: receive the current input data from the user; receive the hidden state data from the encoder; and predict the destination location based on the hidden state data and the current input data.

According to an embodiment, the method may include determining personalized preference data of the user based on the hidden state data, the current input data and a first predetermined weight using the decoder.

According to an embodiment, the method may include predicting the destination location based on the personalized preference data and the hidden state data with a second predetermined weight using the decoder.

According to an embodiment, the method may include determining a probability that the destination location predicted is a correct destination location using the decoder.

The present disclosure generally relates to a non-transitory computer-readable medium storing computer executable code comprising instructions for predicting a destination location according to the present disclosure.

The present disclosure generally relates to a computer executable code comprising instructions for predicting a destination location according to the present disclosure.

To the accomplishment of the foregoing and related ends, the one or more embodiments include the features hereinafter fully described and particularly pointed out in the claims. The following description and the associated drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 illustrates a schematic diagram of a system 100 according to an embodiment of the present disclosure.

FIG. 2 shows a flowchart of a method 200 according to various embodiments.

FIG. 3 illustrates an exemplary destination recommendation interface according to various embodiments.

FIG. 4 illustrates exemplary relationships between origins and destinations according to various embodiments.

FIG. 5A illustrates exemplary relationships between origins and destinations in a local view according to various embodiments.

FIG. 5B illustrates exemplary relationships between origins and destinations in a global view according to various embodiments.

FIG. 6 illustrates a schematic diagram of a recurrent neural network according to an embodiment of the present disclosure.

FIG. 7 illustrates a schematic diagram of an encoder and a decoder system according to an embodiment of the present disclosure.

FIG. 8A illustrates exemplary statistics of datasets according to various embodiments.

FIG. 8B illustrates exemplary performance of the datasets SE-1 to SE-4 of FIG. 8A according to various embodiments.

FIG. 8C illustrates exemplary performance of the datasets SE-5 to SE-7 of FIG. 8A according to various embodiments.

FIG. 9 illustrates a schematic diagram of an encoder and a decoder system according to an embodiment of the present disclosure.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the systems or server or methods or computer program are analogously valid for the other systems or server or methods or computer program and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “exemplary” is used herein to mean “serving as an example, instance, or illustration.” Any embodiment or design described herein as “exemplary” is not necessarily to be construed as preferred or advantageous over other embodiments or designs.

In the context of various embodiments, the articles “a”, “an”, and “the” as used with regard to a feature or element include a reference to one or more of the features or elements.

As used herein, the term “and/or” includes any and all combinations of one or more of the associated listed items.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as used herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

As used herein, the term “geohash” may be predefined geocoded cells of partitioned areas of a city or country.

The following detailed description refers to the accompanying drawings that show, by way of illustration, specific details and aspects in which the present disclosure may be practiced. These aspects are described in sufficient detail to enable those skilled in the art to practice the present disclosure. Various aspects are provided for the present system, and various aspects are provided for the methods. It will be understood that the basic properties of the system also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

To more readily understand and put into practical effect, the present system, method, and other particular aspects will now be described by way of examples and not limitations, and with reference to the figures. For the sake of brevity, duplicate descriptions of features and properties may be omitted.

It will be understood that any property described herein for a specific system or device may also hold for any system or device described herein. It will also be understood that any property described herein for a specific method may hold for any of the methods described herein. Furthermore, it will be understood that for any device, system, or method described herein, not necessarily all the components or operations described will be enclosed in the device, system, or method, but only some (but not all) components or operations may be enclosed.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

The term “entity” herein may be understood as a human user, a business, a group of users or an organization.

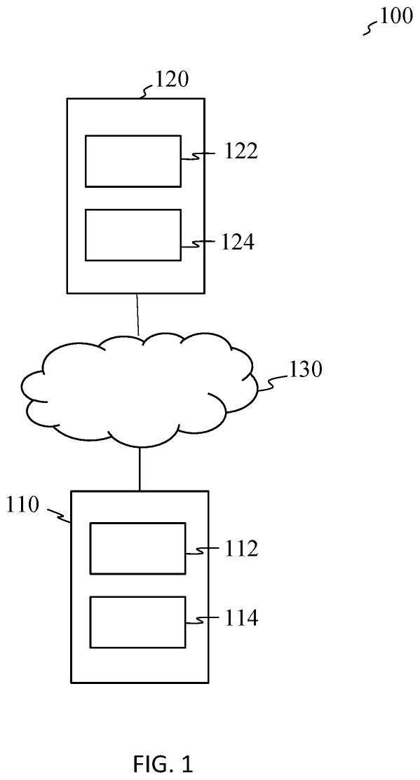

FIG. 1 illustrates a schematic diagram of a system 100 according to an embodiment of the present disclosure.

According to various embodiments, the system 100 may include a server 110, and/or a user device 120.

In various embodiments, the server 110 and the user device 120 may be in communication with each other through communication network 130. In an embodiment, even though FIG. 1 shows a line connecting the server 110 to the communication network 130, a line connecting the user device 120 to the communication network 130, the server 110, and the user device 120 may not be physically connected to each other, for example through a cable. In an embodiment, the server 110, and the user device 120 may be able to communicate wirelessly through communication network 130 by internet communication protocols or through a mobile cellular communication network.

In various embodiments, the server 110 may be a single server as illustrated schematically in FIG. 1, or have the functionality performed by the server 110 distributed across multiple server components. In an embodiment, the server 110 may include one or more server processor(s) 112. In an embodiment, the various functions performed by the server 110 may be carried out across the one or more server processor(s). In an embodiment, each specific function of the various functions performed by the server 110 may be carried out by specific server processor(s) of the one or more server processor(s).

In an embodiment, the server 110 may include a memory 114. In an embodiment, the server 110 may also include a database. In an embodiment, the memory 114 and the database may be one component or may be separate components. In an embodiment, the memory 114 of the server may include computer executable code defining the functionality that the server 110 carries out under control of the one or more server processor 112. In an embodiment, the database and/or memory 114 may include historical data of past transportation service, e.g., a origin location and/or destination location, and/or time at origin location, and/or time at destination location and/or user profile, e.g., user identity and/or user preference. In an embodiment, the memory 114 may include or may be a computer program product such as a non-transitory computer-readable medium.

According to various embodiments, a computer program product may store the computer executable code including instructions for predicting a destination location according to the various embodiments. In an embodiment, the computer executable code may be a computer program. In an embodiment, the computer program product may be a non-transitory computer-readable medium. In an embodiment, the computer program product may be in the system 100 and/or the server 110.

In some embodiments, the server 110 may also include an input and/or output module allowing the server 110 to communicate over the communication network 130. In an embodiment, the server 110 may also include a user interface for user control of the server 110. In an embodiment, the user interface may include, for example, computing peripheral devices such as display monitors, user input devices, for example, touchscreen devices and computer keyboards.

In an embodiment, the user device 120 may include a user device memory 122. In an embodiment, the user device 120 may include a user device processor 124. In an embodiment, the user device memory 122 may include computer executable code defining the functionality the user device 120 carries out under control of the user device processor 124. In an embodiment, the user device memory 122 may include or may be a computer program product such as a non-transitory computer-readable medium.

In an embodiment, the user device 120 may also include an input and/or output module allowing the user device 120 to communicate over the communication network 130. In an embodiment, the user device 120 may also include a user interface for the user to control the user device 120. In an embodiment, the user interface may be a touch panel display. In an embodiment, the user interface may include a display monitor, a keyboard or buttons.

In an embodiment, the system 100 may be used for predicting a destination location. In an embodiment, the memory 114 may have instructions stored therein. In an embodiment, the instructions, when executed by the one or more processors may cause the processor 112 to use at least one recurrent neural network to predict a destination location.

In an embodiment, the processor 112 may use at least one recurrent neural network to process spatial data which may include a first set of information about origin locations and destination locations.

In an embodiment, the processor 112 may use at least one recurrent neural network to process temporal data which may include a second set of information about times at the origin locations and the destination locations.

In an embodiment, the processor 112 may use at least one recurrent neural network to determine hidden state data based on the spatial data and the temporal data. In an embodiment, the hidden state data may include data on origin-destination relationships.

In an embodiment, the processor 112 may use at least one recurrent neural network to receive a current input data from a user. In an embodiment, the current input data may include an identity of the user and the current origin location of the user.

In an embodiment, the processor 112 may use at least one recurrent neural network to predict the destination location based on the hidden state data and the current input data.

In an embodiment, the current input data received from the user may include a previous destination of the user. In an embodiment, the previous destination of the user may be used to predict the destination location.

In an embodiment, the first set of information may include local origin locations and/or local destination locations. In an embodiment, the second set of information may include times at the local origin locations and/or the local destination locations. In an embodiment, the local origin locations and/or the local destination locations may be within a geohash. The term “geohash” may be predefined geocoded cells of partitioned areas of a city or country.

In an embodiment, the first set of information may include global origin locations and/or global destination locations In an embodiment, the second set of information may include times at the global origin locations and/or the global destination locations In an embodiment, the global origin locations and/or the global destination locations may be outside of the geohash.

In an embodiment, the system 100 may include an encoder. In an embodiment, the encoder may be configured to process the spatial data and the temporal data. In an embodiment, the encoder may be configured to determine the hidden state data.

In an embodiment, the system 100 may include a decoder. In an embodiment, the decoder may be configured to receive the current input data from the user. In an embodiment, the decoder may be configured to receive the hidden state data from the encoder. In an embodiment, the decoder may be configured to predict the destination location based on the hidden state data and the current input data.

In an embodiment, the decoder may be configured to determine personalized preference data of the user based on the hidden state data, the current input data and a first predetermined weight.

In an embodiment, the decoder may be configured to predict the destination location based on the personalized preference data and the hidden state data with a second predetermined weight.

In an embodiment, the decoder may be configured to determine a probability that the destination location predicted is a correct destination location.

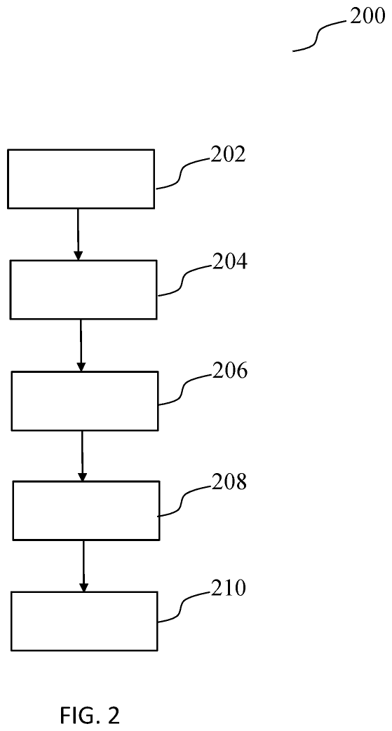

FIG. 2 shows a flowchart of a method 200 according to various embodiments.

According to various embodiments, the method 200 for predicting a destination location may be provided. In an embodiment, the method 200 may include a step 202 of using at least one recurrent neural network to process spatial data. The spatial data may include information about origin locations and destination locations.

In an embodiment, the method 200 may include a step 204 of using at least one recurrent neural network to process temporal data. The temporal data may include information about times at the origin locations and the destination locations.

In an embodiment, the method 200 may include a step 206 of using at least one recurrent neural network to determine origin-destination relationships based on the spatial data and the temporal data.

In an embodiment, the method 200 may include a step 208 of using at least one recurrent neural network to receive a current input data from a user. The current input data may include an identity of the user and the current origin location of the user.

In an embodiment, the method 200 may include a step 210 of using at least one recurrent neural network to predict the destination location based on the origin-destination relationships and the current input data.

In an embodiment, steps 202 to 210 are shown in a specific order, however other arrangements are possible. Steps may also be combined in some cases. Any suitable order of steps 202 to 210 may be used.

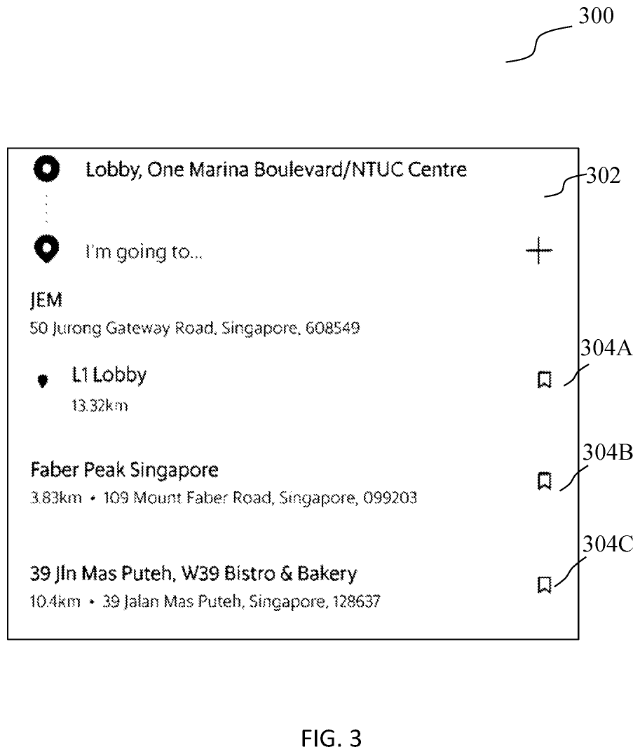

FIG. 3 illustrates an exemplary destination recommendation interface according to various embodiments.

In an embodiment, the exemplary destination recommendation interface 300 may include a current origin location 302. In an embodiment, there may include at least one recommended destination for the current origin location 302. In an embodiment, the at least one recommended destination may be predicted by a system for predicting a destination location. In an embodiment, the system may predict the top X destination locations that a user may travel to from the current origin location 302, where X may be a predetermined value. In an embodiment, the system may predict the top X destination locations based on a user identity. That is, the top X destinations locations from the current origin location 302 may differ from different users.

In an embodiment, at least one recommended destination may include a first recommended destination 304A. In an embodiment, at least one recommended destination may include a second recommended destination 304B. In an embodiment, at least one recommended destination may include a third recommended destination 304C. In an embodiment, the first recommended destination 304A may be a destination which the system predicts to be the most likely destination. In an embodiment, the third recommended destination 304C may be a destination which the system predicts to be the most unlikely destination out of all the recommended locations.

In an embodiment, the following problem formulation may be used:

Let U={u₁, u₂, . . . , u_{M}} be the set of M users and L={l₁, l₂, . . . , l_{N}} be the set of N locations for the users in U to visit, where each location lₙ∈L may either have the role of an origin o or a destination d, or both among the dataset of user trajectories. Each user uₘ may have an OD sequence of pick-up (origin) and drop-off (destination) tuples sᵤ_{ₘ}={(oₜ_{₁},dₜ_{₁}), (oₜ_{₂}, dₜ_{₂}), . . . , (oₜ_{ᵢ}, dₜ_{ᵢ})} that may record their taxi trips, and S={sᵤ_{₁}, sᵤ_{₂}, . . . , sᵤ_{_{M}}} may be the set of all users' OD sequences. All location visits in S, regardless of origin or destination may have their own location coordinates LC and timestamp time.

In an embodiment, the objective of the origin-aware next destination recommendation task may be to consider at least one of: the user uₘ, the current origin oₜ_{ᵢ}, and the historical sequence of OD tuples {(oₜ_{₁}, dₜ_{₁}) (oₜ_{₂}, dₜ_{₂}), . . . , (oₜ_{ᵢ₋₁}, dₜ_{ᵢ₋₁})} to recommend an ordered set of destinations from L. In an embodiment, the next destination dₜ_{ᵢ} may be highly ranked in the recommendation set. In an embodiment, sᵤ_{ₘ}^{train} and S^{train} may be sets from the training partition with the superscript train for clarity.

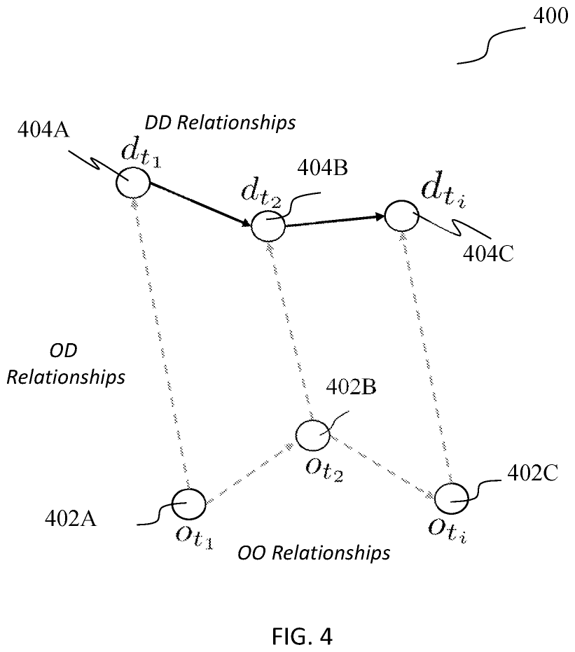

FIG. 4 illustrates exemplary relationships between origins and destinations according to various embodiments.

In a map 400 of FIG. 4, at least one origin location may be in the map 400. The at least one origin location may include a first origin location 402A, a second origin location 402B, and a third origin location 402C.

In the map 400 of FIG. 4, at least one destination location may be in the map 400. The at least one destination location may include a first destination location 402A, a second destination location 402B, and a third destination location 402C.

In an embodiment, the at least one destination location may be used to learn and/or predict the next destination by learning destination-destination (DD) relationships.

In an embodiment, the inclusion of origin location such as an origin sequence or information may help to learn origin-origin (00) and/or origin-destination (OD) relationships.

Origin-origin (00) and/or origin-destination (OD) relationships and/or how to include origin information is not studied by existing works and methods. An advantage of learning origin-origin (00) and/or origin-destination (OD) relationships may result in a model which may optimally learn from both sequences can best perform the task.

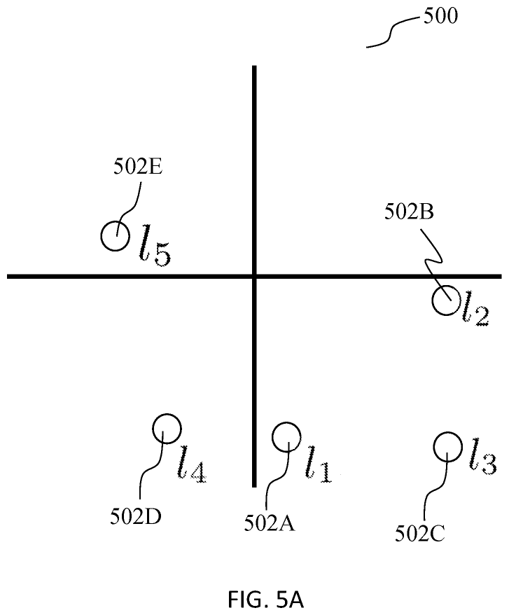

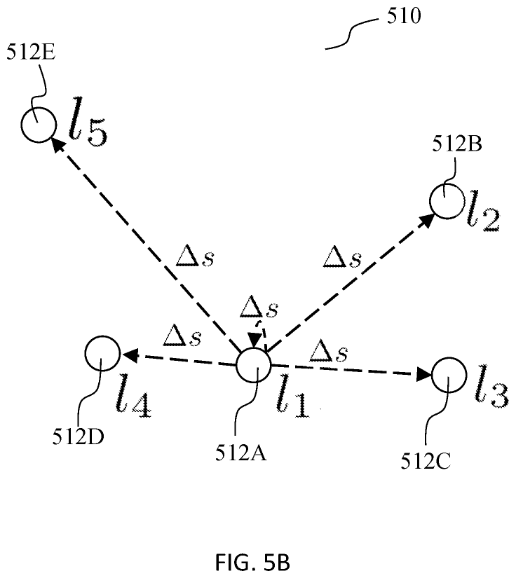

FIG. 5A illustrates exemplary relationships between origins and destinations in a local view according to various embodiments.

In a map of FIG. 5A, at least one location may be in the map 500. The at least one destination location may include a first location 502A, a second location 502B, a third location 502C, a fourth location 502D, a fifth location 502E. In an embodiment, for the at least one location, spatial and/or temporal factor may be obtained for each location of the at least one location. In an embodiment, for spatial factors, the relationships between origins and destinations may be obtained. In an embodiment, for temporal factors, time slot embeddings of each location may be obtained. Temporal intervals may also be obtained.

In the map of FIG. 5A, the spatial and the temporal factors may be in a local view. In an embodiment, local views may be considered as locations within a geohash.

FIG. 5B illustrates exemplary relationships between origins and destinations in a global view according to various embodiments.

In a map of FIG. 5B, at least one location may be in the map 510. The at least one destination location may include a first location 512A, a second location 512B, a third location 512C, a fourth location 512D, a fifth location 512E. In an embodiment, for the at least one location, spatial and/or temporal factor may be obtained for each location of the at least one location. In an embodiment, for spatial factors, the relationships between origins and destinations may be obtained. In an embodiment, for temporal factors, time slot embeddings of each location may be obtained. Temporal intervals may also be obtained.

In the map of FIG. 5B, the spatial and the temporal factors may be in a global view. In an embodiment, global views may be considered as locations not within a geohash. In an embodiment, the spatial and/or the temporal factors may be calculated by computing pairwise intervals from a location to all other locations to understand “how far” and “how near” they are.

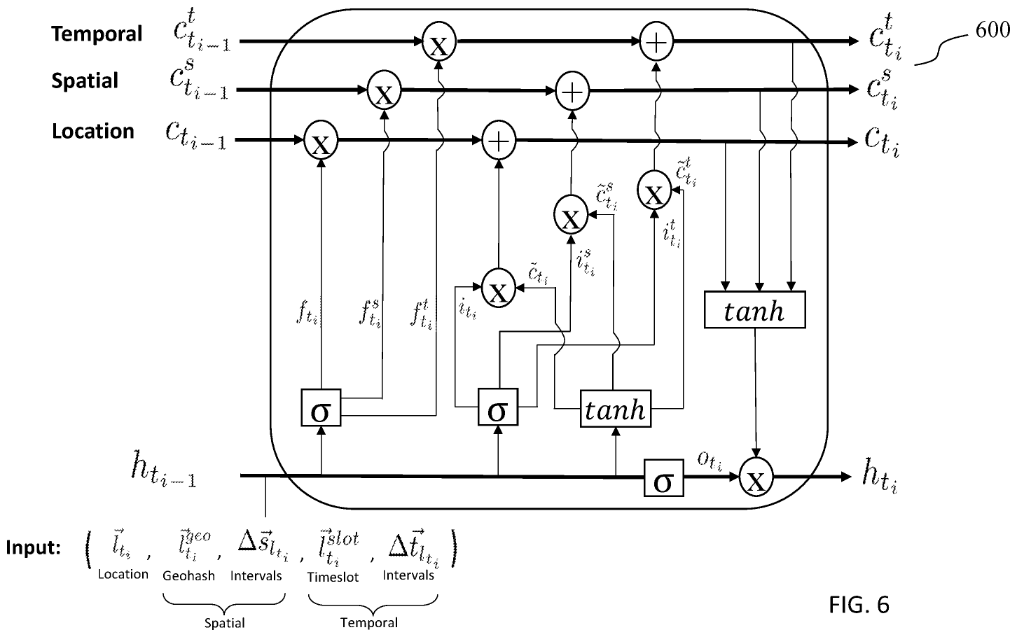

FIG. 6 illustrates a schematic diagram of a recurrent neural network according to an embodiment of the present disclosure.

In an embodiment, the recurrent neural network 600 may be a Spatial-Temporal LSTM (ST-LSTM) model. In an embodiment, an Adam optimizer with cross entropy loss for multi-classification problem may be used to train the model. In an embodiment, the Adam optimizer may have a batch size of 1. The adam optimizer may use 15 epochs and/or a learning rate of 0.0001 for training.

In the example of FIG. 6, the spatial and the temporal factors may be incorporated into new spatial and temporal cell states in an LSTM. In an embodiment, the ST-LSTM model may be an extension of a LSTM model with spatial and temporal cell states. The ST-LSTM model may be used to learn origin-destination relationships based on the spatial and temporal factors in both local and global views. In an embodiment, the extension from a LSTM model to a ST-LSTM model may seek to allow origin-destination relationships to be learned as the LSTM is capable of learning origin-origin or destination-destination relationships given an origin or a destination sequence respectively, but is unable to learn origin-destination relationships.

In an embodiment, given an input location \vec{lₜ_{ᵢ}} for timestep tᵢ, Wᵢ^{s}, W_{f}^{s}, W_{c}^{s} and Vᵢ^{s}, V_{f}^{s}, V_{c}^{s} may be the corresponding weight matrices for the spatial cell state's input and forget gates (i.e. iₜ_{ᵢ}^{s} and fₜ_{ᵢ}^{s}), and cell input [symbol] . These weight matrices may learn representations for the location's geohash embedding \vec{lₜ_{ᵢ}^{geo}} and spatial interval vector

$$Δ \vec{{s}_{{l}_{{t}_{i}}}} .$$

Uᵢ^{s}, U_{f}^{s}, U_{c}^{s} weight matrices. Corresponding biases bᵢ^{s}, b_{f}^{s}, b_{c}^{s} may learn a representation for the previous hidden state hₜ_{ᵢ₋₁}, which may enforce a recurrent structure and may learn sequential dependencies for the spatial cell state. After computing the representations, activation functions of sigmoid σ and hyperbolic tangent tanh may be applied. Then, the spatial cell state cₜ_{ᵢ}^{s} may be computed from the gates and cell input where ⊙ is the Hadamard product. The following equations may be used to compute the spatial cell state cₜ_{ᵢ}^{s}:

$${i}_{{t}_{i}}^{s} = σ ( {W}_{i}^{s} \vec{{l}_{{t}_{i}}^{g e o}} + {V}_{i}^{s} Δ \vec{{s}_{{l}_{{t}_{i}}}} + {U}_{i}^{s} {h}_{{t}_{i - 1}} + {b}_{i}^{s} )$$

$${f}_{{t}_{i}}^{s} = σ ( {W}_{f}^{s} \vec{{l}_{{t}_{i}}^{g e o}} + {V}_{f}^{s} Δ \vec{{s}_{{l}_{{t}_{i}}}} + {U}_{f}^{s} {h}_{{t}_{i - 1}} + {b}_{f}^{s} )$$

$$= tanh ( {W}_{c}^{s} \vec{{l}_{{t}_{i}}^{g e o}} + {V}_{c}^{s} Δ \vec{{s}_{{l}_{{t}_{i}}}} + {U}_{c}^{s} {h}_{{t}_{i - 1}} + {b}_{c}^{s} )$$

$${c}_{{t}_{i}}^{s} = {f}_{{t}_{i}}^{s} ⊙ {c}_{{t}_{i - 1}}^{s} + {i}_{{t}_{i}}^{s} ⊙ .$$

In an embodiment, the spatial cell state equations may be incorporate values from the local view such as geohash embeddings and values from the global view such as spatial intervals into the spatial cell state cₜ_{ᵢ}^{s}.

In an embodiment, given an input location \vec{lₜ_{ᵢ}} for timestep tᵢ, Wᵢ^{t}, W_{f}^{t}, W_{c}^{t} and Vᵢ^{t}, V_{f}^{t}, V_{c}^{t} may be the corresponding weight matrices for the temporal cell state's input and forget gates (i.e. iₜ_{ᵢ}^{t} and fₜ_{ᵢ}^{t}), and cell input [symbol] . These weight metrices may learn representations for the location's visit timeslot embedding \vec{lₜ_{ᵢ}^{slot}} and temporal interval vector

$$Δ \vec{{t}_{{l}_{{t}_{i}}}} .$$

Uᵢ^{t}, U_{f}^{t}, U_{c}^{t} weight matrices. Corresponding biases bᵢ^{s}, b_{f}^{s}, b_{c}^{s} may learn a representation for the previous hidden state hₜ_{ᵢ₋₁}, which may enforce a recurrent structure and learn sequential dependencies for the temporal cell state. After computing the representations, activation functions of sigmoid a and hyperbolic tangent tanh may be applied. Then, the temporal cell state cₜ_{ᵢ}^{t} may be computed from the gates and cell input where ⊙ may be the Hadamard product. The following equations may be used to compute the temporal cell state cₜ_{ᵢ}^{t}:

$${i}_{{t}_{i}}^{t} = σ ( {W}_{i}^{t} \vec{{l}_{{t}_{i}}^{slot}} + {V}_{i}^{t} Δ \vec{{t}_{{l}_{{t}_{i}}}} + {U}_{i}^{t} {h}_{{t}_{i - 1}} + {b}_{i}^{t} )$$

$${f}_{{t}_{i}}^{t} = σ ( {W}_{f}^{t} \vec{{l}_{{t}_{i}}^{slot}} + {V}_{f}^{t} Δ \vec{{t}_{{l}_{{t}_{i}}}} + {U}_{f}^{t} {h}_{{t}_{i - 1}} + {b}_{f}^{t} )$$

$$= tanh ( {W}_{c}^{t} \vec{{l}_{{t}_{i}}^{slot}} + {V}_{c}^{t} Δ \vec{{t}_{{l}_{{t}_{i}}}} + {U}_{c}^{t} {h}_{{t}_{i - 1}} + {b}_{c}^{t} )$$

$${c}_{{t}_{i}}^{t} = {f}_{{t}_{i}}^{t} ⊙ {c}_{{t}_{i - 1}}^{t} + {i}_{{t}_{i}}^{t} ⊙ .$$

In an embodiment, the temporal cell state equations may be incorporate values from the local view such as timeslot embeddings and values from the global view such as temporal intervals into the spatial cell state cₜ_{ᵢ}^{t}.

In an embodiment, the three hidden states may be fused as the output hidden state for the current timestep. In an embodiment, to compute the hidden state hₜ_{ᵢ} for the ST-LSTM of timestep tᵢ, a representation may be learned with the weight matrix Wₕ from the concatenation ∥ of the cell state cₜ_{ᵢ}, spatial cell state cₜ_{ᵢ}^{s} and temporal cell state cₜ_{ᵢ}^{t}. The representation may be subjected to the hyperbolic tangent function tanh and Hadamard product ⊙ with the LSTM's existing output gate oₜ_{ᵢ}. The following equation may be used to compute the hidden state hₜ_{ᵢ}:

hₜ_{ᵢ}=oₜ_{ᵢ}⊙tanh(Wₕ(cₜ_{ᵢ}∥cₜ_{ᵢ}^{s}∥cₜ_{ᵢ}^{t})

In an embodiment, the spatial and temporal cell states in addition to the LSTM's cell state may enable OD relationships to be learned as the LSTM alone may not be able to learn OD relationships.

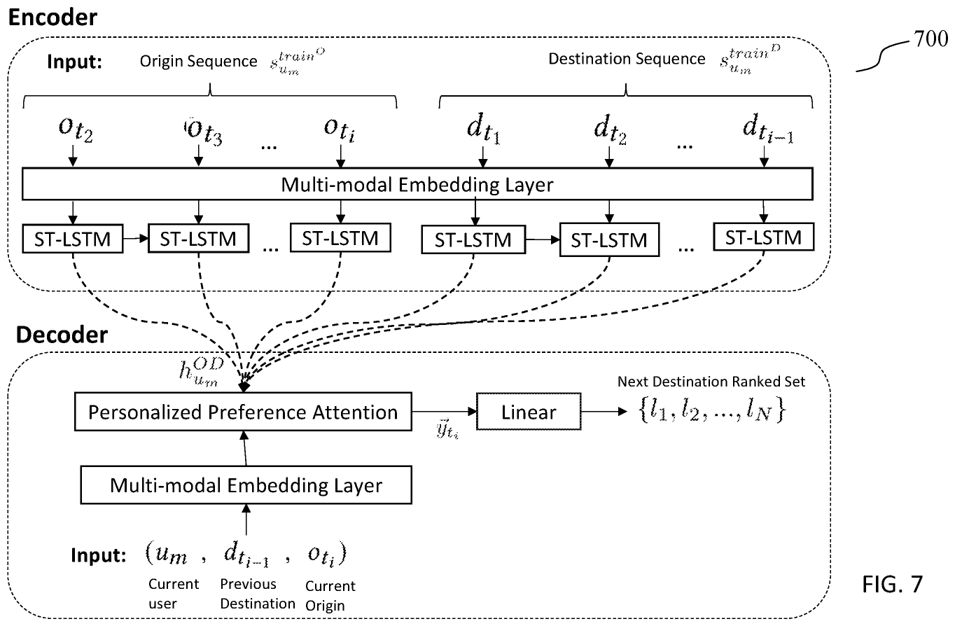

FIG. 7 illustrates a schematic diagram of an encoder and a decoder system according to an embodiment of the present disclosure.

In an embodiment, with the recurrent neural network model (e.g., the ST-LSTM model), a Personalized Preference Attention (PPA) model may be disclosed. The PPA may be a Spatial-Temporal Origin-Destination Personalized Preference Attention (STOD-PPA). The PPA model may be or may use an encoder-decoder framework.

In an embodiment, the system may include an encoder. In an embodiment, the encoder may encode the historical origin and destination sequences of the user to capture their preferences. In an embodiment, the encoder may use the recurrent neural network model to learn OO, DD and OD relationships. In an embodiment, as each user's sequence of OD tuples sᵤ_{ₘ} is partitioned into training and testing partitions, the training partition sᵤ_{ₘ}^{train}={(oₜ_{₁}, dₜ_{₁}), (oₜ_{₂}, dₜ_{₂}), . . . , (oₜ_{ᵢ}, dₜ_{ᵢ})} may be used and may be split into separate origin and destination sequences of sᵤ_{ₘ}^{train}^{^{O}}={oₜ_{₂}, oₜ_{₃}, . . . , oₜ_{ᵢ}} and sᵤ_{ₘ}^{train}^{^{D}}={dₜ_{₁}, dₜ_{₂}, . . . , dₜ_{ᵢ₋₁}} respectively. In an embodiment, for efficiency, the first origin oₜ_{₁} from sᵤ_{ₘ}^{train}^{^{O}} and the last destination dₜ_{ᵢ} from sᵤ_{ₘ}^{train}^{^{D}} may be omitted so that both the encoder and decoder will use the same set of input sequences, which may allow batch training to be performed for each user. In an embodiment, both sᵤ_{ₘ}^{train}^{^{O}} and sᵤ_{ₘ}^{train}^{^{D}} may be encoded separately, with the ST-LSTMs of ϕ^{O} and ϕ^{D} respectively:

hᵤ_{ₘ}^{O}=ϕ^{O}(sᵤ_{ₘ}^{train}^{^{O}})

hᵤ_{ₘ}^{D}=ϕ^{D}(sᵤ_{ₘ}^{train}^{^{D}}).

In an embodiment, this may allow OO and DD relationships to be learned in their own ST-LSTM, as well as OD relationships from the newly proposed spatial and temporal cell states. In an embodiment, both hᵤ_{ₘ}^{O} and hᵤ_{ₘ}^{D} may be concatenated for a final set of all hidden states hᵤ_{ₘ}^{OD} for user uₘ∈U as the output of the encoder, for use by the decoder in training and testing to predict the next destination.

In an embodiment, the system may include a decoder. In an embodiment, the decoder may encode the encoded hidden states to perform the predictive task of the next destination or drop-off point given the current origin, and/or previous destination and/or the user ID. In an embodiment, after encoding the OD sequences hᵤ_{ₘ}^{OD}, the Personalized Preference Attention (PPA) decoder module may be applied to attend to all the encoded OD hidden states and may compute an origin-aware personalized hidden representation based on the users' dynamic preferences.

In an embodiment, this may allow GG and DD relationships to be learned in their own ST-LSTM, as well as OD relationships from the newly proposed spatial and temporal cell states. In an embodiment, both hᵤ_{ₘ}^{O} and hᵤ_{ₘ}^{D} may be concatenated for a final set of all hidden states hᵤ_{ₘ}^{OD} for user uₘ∈U as the output of the encoder, for use by the decoder in training and testing to predict the next destination.

In an embodiment, the decoder may compute an attention score for each encoded hidden state in hᵤ_{ₘ}^{OD}. In an embodiment, the attention score may be computed by taking the embedding inputs of the previous destination \vec{dₜ_{ₜ₋₁}}, current origin \vec{oₜ_{ᵢ}} and current user \vec{uₘ} and each hidden state \vec{hᵢ}∈hᵤ_{ₘ}^{OD} after encoding both origin and destination sequences. In an embodiment, the attention score \vec{αₜ} may be computed using the equation:

$$\vec{{α}_{ι}} = \frac{exp ( {σ}_{L R} ( {W}_{A} ( \vec{{u}_{m}} ‖ \vec{{o}_{{t}_{ι}}} ‖ \vec{{d}_{{t}_{ι - 1}}} ‖ \vec{{h}_{ι}} ) ) )}{{\sum }_{\vec{{p}_{ι}} ∈ {h}_{{u}_{m}}^{OD}} exp ( {σ}_{L R} ( {W}_{A} ( \vec{{u}_{m}} ‖ \vec{{o}_{{t}_{ι}}} ‖ \vec{{d}_{{t}_{ι - 1}}} ‖ \vec{{p}_{ι}} ) ) )} .$$

where W_{A} may be a weight matrix to learn a representation for the concatenated inputs, followed by the Leaky ReLU activation function σ_{LR}, then applying a softmax normalization across hᵤ_{ₘ}^{OD}.

In an embodiment, a weighted sum of the attention scores \vec{αₜ}∈αₜ_{ᵢ} may be applied to each encoded hidden state \vec{hᵢ}∈hᵤ_{ₘ}^{OD} to compute a hidden representation that best represents the user's preferences. In an embodiment, the output hidden representation \vec{yₜ_{ᵢ}} for timestep tᵢ may be calculated using the following equation:

$$\vec{{y}_{{t}_{ι}}} = {\sum }_{\vec{{α}_{ι}} ∈ {α}_{{t}_{i}} , \vec{{h}_{ι}} ∈ {h}_{{u}_{m}}^{OD}} \vec{{α}_{ι}} ⊙ \vec{{h}_{ι}} .$$

In an embodiment, the probability distribution of the next destination may be computed using the equation:

P(dₜ_{ᵢ}|oₜ_{ᵢ},dₜ_{ᵢ₋₁},uₘ)=softmax(W_{loc}(\vec{yₜ_{ᵢ}})).

where \vec{yₜ_{ᵢ}} may be projected to the number of locations or |L| using the weight matrix W_{loc}, followed by a softmax function to derive a probability distribution of all locations by learning P(dₜ_{ᵢ}|oₜ_{ᵢ}, dₜ_{ᵢ₋₁}, uₘ) as a multi-classification problem. Accordingly, we may sort the distribution in descending order to achieve the final ranked recommendation set where the next destination location dₜ_{ᵢ} should be highly ranked.

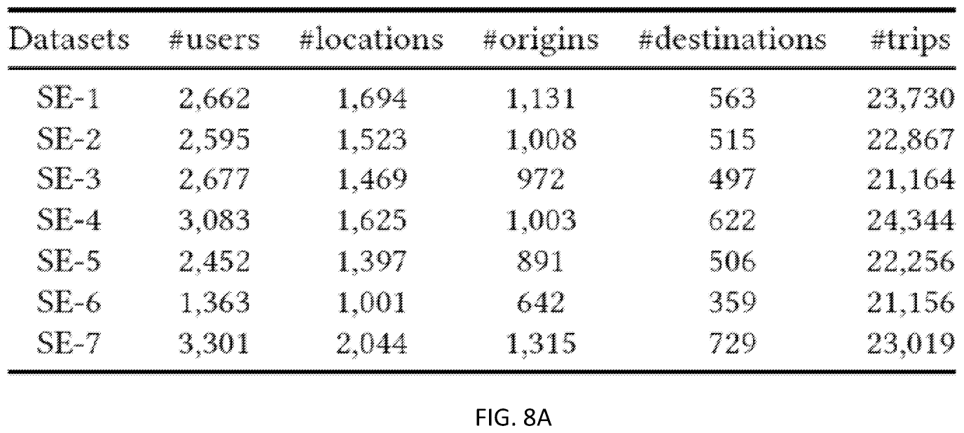

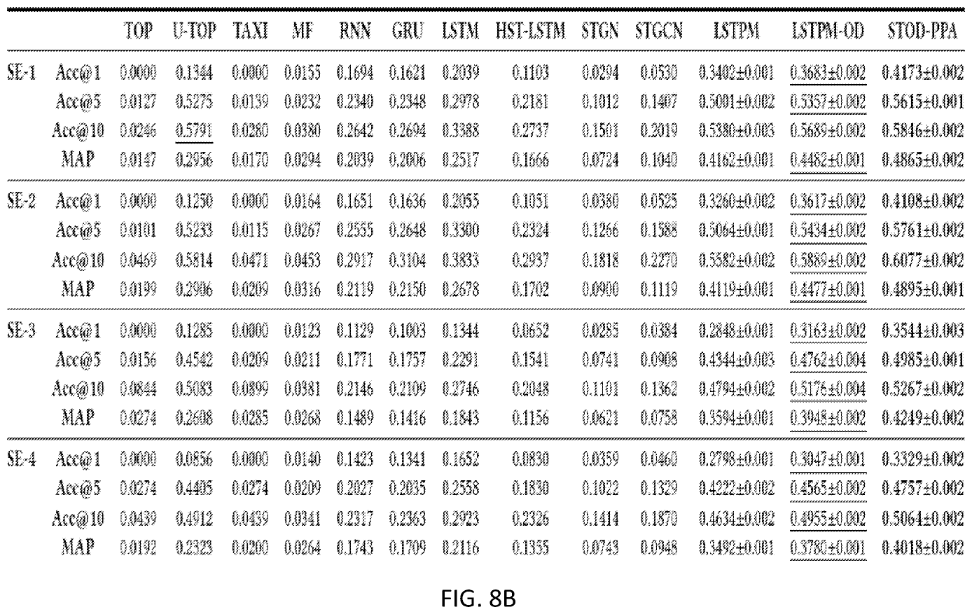

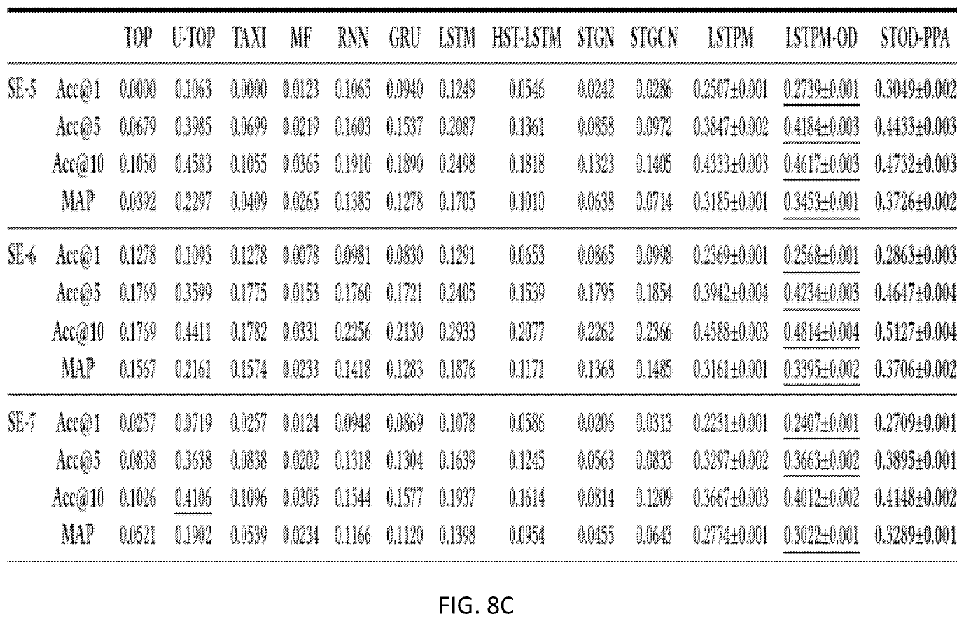

FIG. 8A illustrates exemplary statistics of datasets according to various embodiments.

In FIG. 8A, seven datasets SE1-SE7 are shown. In an embodiment, each dataset may include data indicating at least one of: a number of users, and/or number of locations, and/or number of origin locations, and/or number of destination locations, and/or number of trips. In an embodiment, the number of locations may be equal to the number of origin locations, and the number of destination locations.

FIG. 8B illustrates exemplary performance of the datasets SE-1 to SE-4 of FIG. 8A according to various embodiments. FIG. 8C illustrates exemplary performance of the datasets SE-5 to SE-7 of FIG. 8A according to various embodiments.

In FIGS. 8B and 8C, the evaluation results where the STOD-PPA model surpassed all existing methods is shown. In FIGS. 8B and 8C, the STOD-PPA along with their standard deviations after 10 runs on different random seeds, on surpassing the LSTPM, the LSTPM-OD extension which also considers both origin and destination information for a fair comparison, as well as the other existing methods and baselines, for all datasets and all metrics. Acc@K may evaluate the quality of the ranked list up to K and MAP evaluates the quality of the entire ranked list.

In an embodiment, standard metrics of Acc@K may be used, in which K may be K E {1, 5, 10}. K and Mean Average Precision (MAP) may be used for evaluation. Acc@K may measure the performance of the recommendation set up to K, where the smaller K is, the more challenging it is to perform well. In an embodiment, in Acc@1, a score of 1 may be awarded if the ground truth next destination is in the first position (K=1) of the predicted ranked set, i.e., given the highest probability. In an embodiment, in Acc@1, a score of 0 may be awarded if the ground truth next destination is given the lowest probability. In an embodiment, Acc@K focuses on top K. In an embodiment, MAP may evaluate the quality of the entire recommendation set and/or may measure the overall performance of the model.

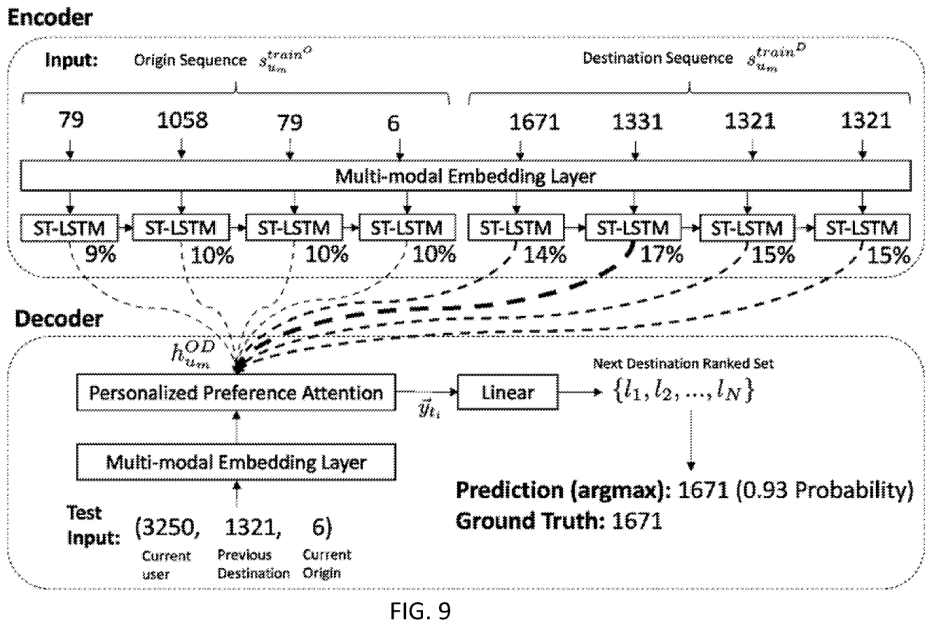

FIG. 9 illustrates a schematic diagram of an encoder and a decoder system according to an embodiment of the present disclosure.

FIG. 9 shows a sample test case from a dataset where the model may be interpreted to understand the user preferences. In an embodiment, a test input tuple of a user ID 3250, previous destination ID 1321 and current origin ID 6, may be used as inputs to the PPA decoder. The PPA decoder may apply the personalized preference attention on the encoded OD hidden states from the user's historical OD sequences. In an embodiment, in the encoder, the corresponding origin and destination ID sequences, as well as attention weights computed for each hidden state (in percentages for clarity), may be done by the PPA decoder. In an embodiment a notable difference of weights computed may be used to best perform the predictive task and may support interpretability. For example, transition from 1671 to 1331 has the highest weight and while origin ID 79 has the lowest weight). In the example, with the ground truth destination ID of 1671, the STOD-PPA approach was able to correctly predict the destination ID 1671 with the highest probability score of 0.93.

While the present disclosure has been particularly shown and described with reference to specific aspects, it should be understood by those skilled in the art that various changes in form and detail may be made therein without departing from the scope of the present disclosure as defined by the appended claims. The scope of the present disclosure is thus indicated by the appended claims and all changes which come within the meaning and range of equivalency of the claims are therefore intended to be embraced.

What is claimed is:

1. A system for predicting a destination location, comprising:
one or more processors; and
a memory having instructions stored therein, the instructions, when executed by the one or more processors, causing the one or more processors to use at least one recurrent neural network to:
process spatial data comprising a first set of information about origin locations and destination locations;
process temporal data comprising a second set of information about times at the origin locations and the destination locations;
determine hidden state data based on the spatial data and the temporal data, wherein the hidden state data comprises data on origin-destination relationships;
receive a current input data from a user, wherein the current input data comprises an identity of the user and the current origin location of the user; and
predict the destination location based on the hidden state data and the current input data.

2. The system of claim 1, wherein the current input data further comprises a previous destination of the user.

3. The system of claim 1, wherein the first set of information comprises local origin locations and local destination locations, wherein the second set of information comprises times at the local origin locations and the local destination locations, and wherein the local origin locations and the local destination locations are within a geohash.

4. The system of claim 3, wherein the first set of information comprises global origin locations and global destination locations, wherein the second set of information comprises times at the global origin locations and the global destination locations, and wherein the global origin locations and the global destination locations are outside of the geohash.

5. The system of claim 1, further comprising:
an encoder configured to process the spatial data and the temporal data and configured to determine the hidden state data.

6. The system of claim 5, further comprising:
a decoder configured to receive the current input data from the user, to receive the hidden state data from the encoder, and to predict the destination location based on the hidden state data and the current input data.

7. The system of claim 6, wherein the decoder is configured to determine personalized preference data of the user based on the hidden state data, the current input data and a first predetermined weight.

8. The system of claim 7, wherein the decoder is configured to predict the destination location based on the personalized preference data and the hidden state data with a second predetermined weight.

9. The system of claim 6, wherein the decoder is configured to determine a probability that the destination location predicted is a correct destination location.

10. A method for predicting a destination location, comprising:
using at least one recurrent neural network to:
process spatial data comprising information about origin locations and destination locations;
process temporal data comprising information about times at the origin locations and the destination locations;
determine origin-destination relationships based on the spatial data and the temporal data;
receive a current input data from a user, wherein the current input data comprises an identity of the user and the current origin location of the user; and
predict the destination location based on the origin-destination relationships and the current input data.

11. The method of claim 10, wherein the current input data further comprises a previous destination of the user.

12. The method of claim 10, wherein the first set of information comprises local origin locations and local destination locations, wherein the second set of information comprises times at the local origin locations and the local destination locations, and wherein the local origin locations and the local destination locations are within a geohash.

13. The method of claim 12, wherein the first set of information comprises global origin locations and global destination locations, wherein the second set of information comprises times at the global origin locations and the global destination locations, and wherein the global origin locations and the global destination locations are outside of the geohash.

14. The method of claim 10, further comprising:
using an encoder to:
process the spatial data and the temporal data; and
determine the hidden state data.

15. The method of claim 14, further comprising:
using a decoder to:
receive the current input data from the user;
receive the hidden state data from the encoder; and
predict the destination location based on the hidden state data and the current input data.

16. The method of claim 15, further comprising:
determining personalized preference data of the user based on the hidden state data, the current input data and a first predetermined weight using the decoder.

17. The method of claim 16, further comprising:
predicting the destination location based on the personalized preference data and the hidden state data with a second predetermined weight using the decoder.

18. The method of claim 15, further comprising:
determining a probability that the destination location predicted is a correct destination location using the decoder.

19. A non-transitory computer-readable medium storing computer executable code comprising instructions for predicting a destination location according to a method for predicting a destination location, the method comprising:
using at least one recurrent neural network to:
process spatial data comprising information about origin locations and destination locations;
process temporal data comprising information about times at the origin locations and the destination locations;
determine origin-destination relationships based on the spatial data and the temporal data;
receive a current input data from a user, wherein the current input data comprises an identity of the user and the current origin location of the user; and
predict the destination location based on the origin-destination relationships and the current input data.

20. (canceled)
